(19) United States
(12) Patent Application Publication
(10) Pub. No.: US 2023/0415362 A1
(43) Pub. Date: Dec. 28, 2023

(54) WATERPROOF MECHANISM FOR ROBOT HAND

(71) Applicant: SHINANO KENSHI CO., LTD., Nagano (JP)

(72) Inventor: Yukio SHINOZUKA, Nagano (JP)

(73) Assignee: SHINANO KENSHI CO., LTD., Nagano (JP)

(21) Appl. No.: 18/144,929

(22) Filed: May 9, 2023

(30) Foreign Application Priority Data
Jun. 28, 2022 (JP) 2022-103894

(51) Int. Cl. B25J 19/00

(52) U.S. Cl. CPC B25J 19/0083; B25J 15/10

(57) ABSTRACT

A waterproof mechanism, for a robot hand, includes a cover covering at least a part of a main body portion of the robot hand, covering a driving portion, and including an opening; and an extension member protruding from the opening, wherein the driving portion is held so as to be driven with respect to the main body portion, a proximal end portion of the extension member is fixed to the driving portion, a distal end portion of the extension member is fixed to a claw member of the robot hand, a first fixing member that fixes the extension member and the driving portion to each other is covered by the cover, and a second fixing member that fixes the extension member and the claw member to each other is detachably exposed from the cover.

### CROSS-REFERENCE TO RELATED APPLICATION

This application is based upon and claims the benefit of priority of the prior Japanese Patent Application No. 2022-103894, filed on Jun. 28, 2022, the entire contents of which are incorporated herein by reference.

### BACKGROUND

### (i) Technical Field

The present disclosure relates to a waterproof mechanism for a robot hand.

### (ii) Related Art

Japanese Unexamined Patent Application Publication No. 2015-039726 discloses a cover as a waterproof mechanism for a robot hand.

In Japanese Unexamined Patent Application Publication No. 2015-039726, in order to replace claw members of the robot hand, it is needed to remove the cover. Therefore, the replacement workability of the claw members is low. In addition, it is needed to prepare a cover corresponding to the shape of the claw members. Therefore, the versatility of the cover is low.

### SUMMARY

According to an aspect of the present disclosure, there is provided a waterproof mechanism for a robot hand, the waterproof mechanism including: a cover covering at least a part of a main body portion of the robot hand, covering a driving portion, and including an opening; and an extension member protruding from the opening, wherein the driving portion is held so as to be driven with respect to the main body portion, a proximal end portion of the extension member is fixed to the driving portion, a distal end portion of the extension member is fixed to a claw member of the robot hand, a first fixing member that fixes the extension member and the driving portion to each other is covered by the cover, and a second fixing member that fixes the extension member and the claw member to each other is detachably exposed from the cover.

### BRIEF DESCRIPTION OF THE DRAWINGS

FIG. 1 is an external perspective view of a robot hand;

FIG. 2 is an external perspective view of a state in which a resin cover and a rubber cover are assembled to the robot hand;

FIG. 3 is an external side view of a state in which the resin cover and the rubber cover are assembled to the robot hand;

FIG. 4 is an external perspective view of the rubber cover in a state in which the extension member passes through a movable portion with claw members removed;

FIG. 5 is an external perspective view of the rubber cover;

FIG. 6 is an external perspective view of the extension member in a state where the claw member is attached;

FIG. 7 is an external perspective view of the extension member; and

FIG. 8 is a cross-sectional view of the extension members and the rubber cover in a state where the claw members are attached.

### DETAILED DESCRIPTION

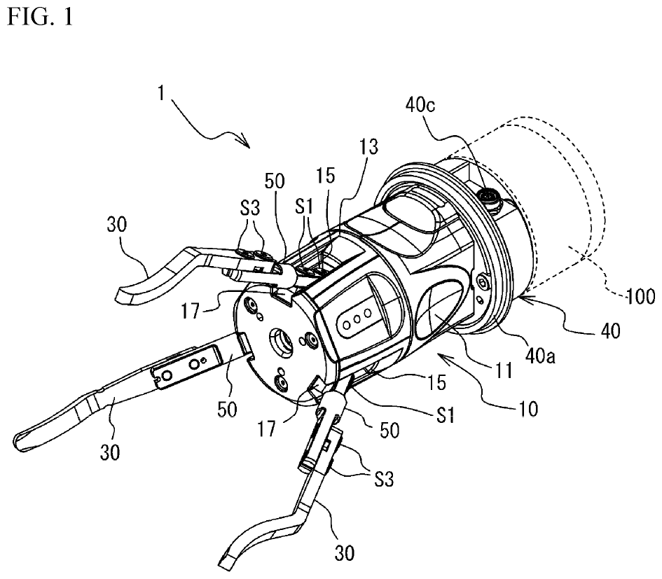

It is assumed that a robot hand to which the waterproof mechanism of the present embodiment is applied is a robot hand having a structure in which claw members can be easily detached as disclosed in, for example, Japanese Patent No. 6858301. FIG. 1 is an external perspective view of a robot hand 1. The robot hand 1 includes a main body portion 10 and claw members 30. The main body portion 10 includes a motor portion 11 and a bracket portion 13. A motor serving as a driving source for opening and closing the claw members 30 is accommodated in the motor portion 11. The motor is, for example, a stepping motor.

An attachment 40 is connected to a proximal end of the main body portion 10. The attachment 40 is connected to a distal end portion of a robot arm 100. Therefore, the attachment 40 functions as a relay member that connects the robot arm 100 and the main body portion 10. The attachment 40 has a cylindrical shape and is made of, for example, an aluminum alloy. A connector 40c is provided on an outer peripheral portion of the attachment 40. A wire is provided in the attachment 40. This wire electrically connects the connector 40c and the motor in the motor portion 11. A power supply wire and a control wire are connected to the connector 40c. The power supply wire is a wire for driving the motor. The control wire is a wire for controlling the operation of the robot hand 1 by controlling the driving of the motor.

The bracket portion 13 is located on the distal end of the motor portion 11. The claw member 30 is swingably held by the main body portion 10 via an extension member 50, which will be described in detail later. The bracket portion 13 has a substantially cylindrical shape with a lid. Three clearance holes 15 are formed in the outer peripheral side surface of the bracket portion 13. The clearance hole 15 is provided so that a part of a driving portion 17 is exposed. The driving portion 17 is swingably supported by the bracket portion 13. The driving force of the motor is transmitted to the driving portion 17 via a gear or the like disposed inside the bracket portion 13. As a result, the driving portion 17 swings within a predetermined range.

A proximal end portion of the extension member 50 is fixed to the driving portion 17 by two screws S1. The proximal end portion of the claw member 30 is fixed to the distal end portion of the extension member 50 by two screws S3. Therefore, when the driving portion 17 swings, the extension member 50 and the claw member 30 swing. Thus, the claw members 30 are opened and closed. The screw S1 is an example of a first fixing member. The screw S3 is an example of a second fixing member. Note that the distal end portion of the extension member 50 to which the proximal end portion of the claw member 30 is fixed, and the location of the driving portion 17 to which the proximal end portion of the extension member 50 is fixed are interchangeable in shape. The above-described “robot hand having a structure in which the claw members can be easily detached” which is a premise of the present embodiment is used by directly fixing the claw member 30 to the driving portion 17 when the waterproof mechanism of the present embodiment is not applied. However, when the waterproof mechanism of the present embodiment is applied, the extension member 50 is required to use a rubber cover described later. That is, the extension member 50 is attached as a post-attachment component to an existing “robot hand having a structure in which a claw members can be easily detached”. A screw portion 40a is formed at the distal end of the attachment 40. A male screw portion is formed on an outer periphery of the screw portion 40a.

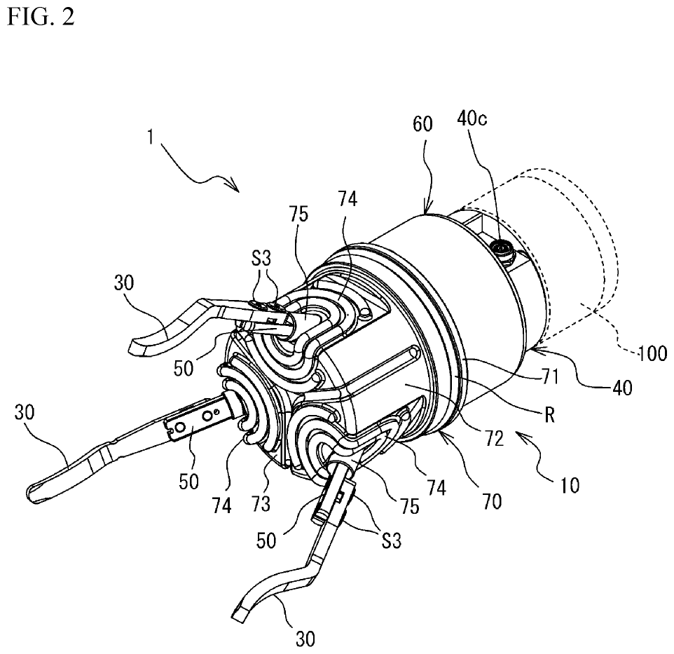

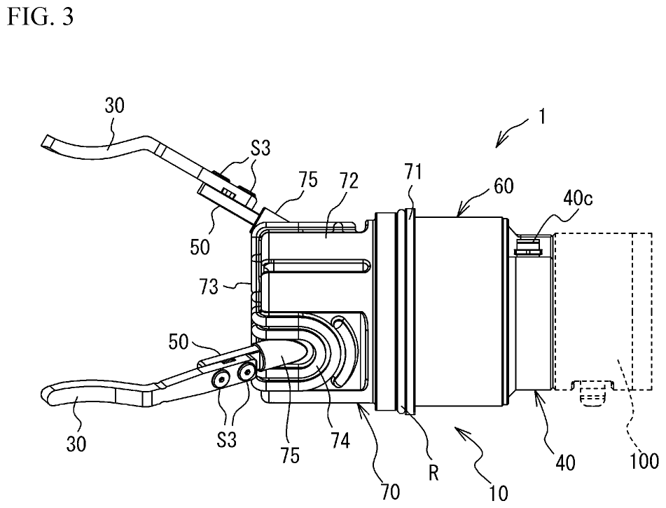

FIG. 2 is an external perspective view of a state in which a resin cover 60 and the rubber cover 70 are assembled to the robot hand 1. FIG. 3 is an external side view of a state in which the resin cover 60 and the rubber cover 70 are assembled to the robot hand 1. The resin cover 60 covers the motor portion 11 located on the proximal end of the main body portion 10. The rubber cover 70 covers the bracket portion 13 located on the distal end side of the main body portion 10, and more specifically covers the clearance hole 15, the driving portion 17, and the screw S1. In this way, the waterproof property of the robot hand 1 is ensured by the attachment 40, the resin cover 60, and the rubber cover 70.

The resin cover 60 is made of a synthetic resin having inflexibility and has optical transparency. The resin cover 60 has a substantially cylindrical shape. A female screw portion is formed on the inner peripheral surface of the proximal end portion of the resin cover 60. The proximal end portion of the resin cover 60 crushes an O-ring (not illustrated) and is screwed into the screw portion 40a of the attachment 40. In this way, the resin cover 60 is attachable to and detachable from the main body portion 10.

The resin cover 60 has optical transparency. Therefore, in a state where the resin cover 60 is attached to the main body portion 10, the external appearance of the main body portion 10 can be visually recognized through the resin cover 60. Therefore, for example, in a case where a lamp or the like indicating the driving state of the claw members 30 is provided in the main body portion 10, by covering the lamp portion with the resin cover 60, the visibility of the lamp is secured and the waterproofness is also secured. In addition, even if moisture enters the resin cover 60, it is easy to quickly find the moisture. The resin cover 60 is an example of a non-flexible portion. Note that only a portion of the resin cover 60 may have optical transparency. In addition, the resin cover 60 is not limited to having optical transparency. Although a metal cover may be used instead of the resin cover 60, a synthetic resin cover is preferably used from the viewpoint of visibility and weight reduction.

The rubber cover 70 is made of rubber and has flexibility. The rubber cover 70 includes a tubular portion 72 and a lid portion 73. The tubular portion 72 has a substantially cylindrical shape. The lid portion 73 is continuous with the tubular portion 72 and has a disk shape perpendicular to the central axis of the tubular portion 72. A fitting portion 71 is formed on the proximal end of the tubular portion 72. The fitting portion 71 is fitted to the distal end portion of the resin cover 60 from the outside. A ring groove 71r, which will be described later, is formed on outer surface of the fitting portion 71. An O-ring R is fitted into the ring groove 71r. As a result, the rubber cover 70 can be attached to and detached from the main body portion 10 while the adhesion between the rubber cover 70 and the resin cover 60 is ensured.

As will be described in detail later, a movable portion 75 protrudes outward from a boundary between the tubular portion 72 and the lid portion 73. The extension member 50 extends so as to pass through the movable portion 75. A bellows portion 74 is formed around the movable portion 75.

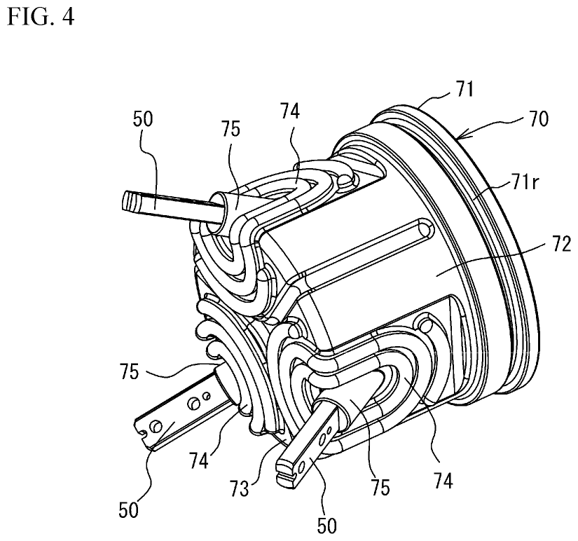

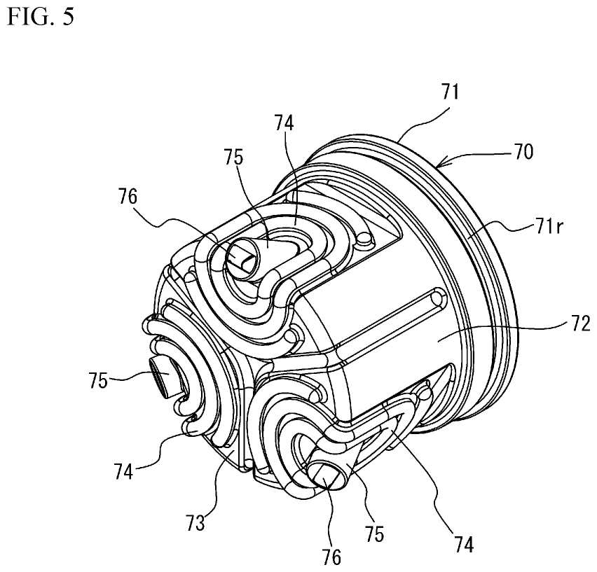

FIG. 4 is an external perspective view of the rubber cover 70 in a state in which the extension member 50 with the claw member 30 removed passes through the movable portion 75. FIG. 5 is an external perspective view of the rubber cover 70. The movable portion 75 is formed in a substantially cylindrical shape. An opening 76 through which the extension member 50 passes is formed at the distal end of the movable portion 75. The opening 76 has a substantially rectangular shape. As illustrated in FIG. 5, the ring groove 71r is formed in the fitting portion 71.

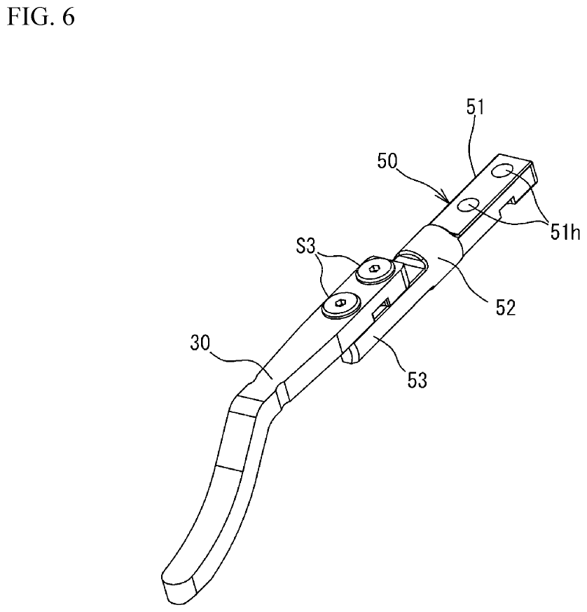

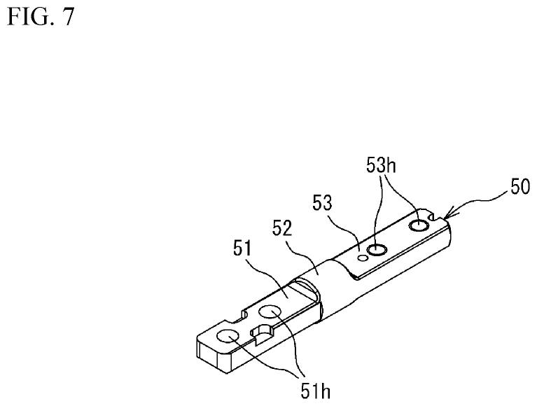

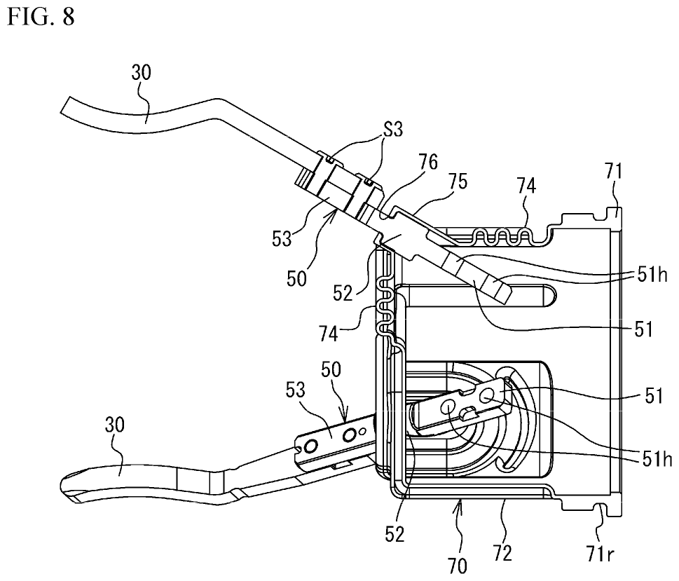

Next, the extension member 50 will be described. FIG. 6 is an external perspective view of the extension member 50 to which the claw member 30 is attached. FIG. 7 is an external perspective view of the extension member 50. FIG. 8 is a cross-sectional view of the extension member 50 and the rubber cover 70 in a state where the claw member 30 is attached.

The extension member 50 has a rod shape extending substantially linearly and is made of an aluminum alloy. The extension member 50 includes a narrow portion 51, an enlarged portion 52, and a narrow portion 53 in this order from the proximal end to the distal end. Two through holes 51h are formed in the narrow portion 51. A screw S1 for fixing the extension member 50 to the driving portion 17 passes through the through hole 51h. Two screw holes 53h are formed in the narrow portion 53. A screw S3 for fixing the claw member 30 to the extension member 50 is screwed into the screw hole S3. The narrow portions 51 and 53 extend in a plate shape and have substantially the same thickness, but are not limited thereto.

The length of the enlarged portion 52 may be shorter than the length of each of the narrow portions 51 and 53 as long as it is within a range in which a waterproof function by a complementary shape described later can be obtained. The enlarged portion 52 is located between the narrow portion 51 and the narrow portion 53. The enlarged portion 52 has a substantially cylindrical shape. More specifically, the outer diameter of the enlarged portion 52 is greater than the thickness of each of the narrow portions 51 and 53. The cross-sectional shape perpendicular to the direction in which the narrow portion 53 extends corresponds to the shape of the opening 76 and is substantially rectangular. The narrow portion 53 is sized to pass through the opening 76. The outer diameter of the enlarged portion 52 is larger than the outer diameter of the narrow portion 53. The outer diameter of the enlarged portion 52 is larger than that of the opening 76. The enlarged portion 52 cannot pass through the opening 76. As long as the enlarged portion 52 cannot pass through the opening 76, the outer diameter of the enlarged portion 52 may be smaller and the shape of the enlarged portion 52 may be other than a cylindrical shape.

As illustrated in FIG. 8, the enlarged portion 52 is fitted to the movable portion 75. Specifically, the enlarged portion 52 and the movable portion 75 have complementary shapes, and the outer diameter of the enlarged portion 52 and the inner diameter of the movable portion 75 are substantially the same. As a result, the inner surface of the movable portion 75 and the outer surface of the enlarged portion 52 come into close contact with each other. Accordingly, the liquid is prevented from entering the inside of the movable portion 75 through the opening 76. As described above, the attachment 40, the extension member 50, the resin cover 60, and the rubber cover 70 correspond to a waterproof mechanism for the robot hand 1.

As described above, the rubber cover 70 has flexibility. Therefore, the movement of the extension member 50 that swings in accordance with the swing of the driving portion 17 is allowed. Further, as described above, the bellows portion 74 is formed around the movable portion 75. The bellows portion 74 is formed over the tubular portion 72 and the lid portion 73. Accordingly, the bellows portion 74 expands and contracts so as to absorb the movement of the extension member 50. Therefore, the stress caused by the movement of the extension member 50 is dispersed over a wide range of the bellows portion 74. Therefore, repeated concentration of stress on a part of the rubber cover 70 is suppressed, and partial deterioration of the rubber cover 70 is suppressed. In addition, the force that hinders the swing motion of the extension member 50 with respect to the rubber cover 70 is reduced.

The movable portion 75 is formed at a boundary between the tubular portion 72 and the lid portion 73. In other words, the movable portion 75 is formed across the tubular portion 72 and the lid portion 73. If the movable portion 75 is formed on the tubular portion 72 away from the lid portion 73, it might be difficult for the movable portion 75 to be deformed so as to fall down to the lid portion 73. As a result, it might be difficult to close the claw member 30. On the other hand, when the movable portion 75 is formed on the lid portion 73 away from the tubular portion 72, it might be difficult for the movable portion 75 to be deformed so as to fall radially outward. As a result, it might be difficult to open the claw member 30. In the present embodiment, the movable portion 75 is formed at a boundary between the tubular portion 72 and the lid portion 73. Therefore, the opening and closing operation of the claw member 30 is easy.

As described above, the resin cover 60 is non-flexible. For example, if a rubber cover having flexibility is adopted instead of the resin cover 60, attachment workability of the rubber cover to the main body portion 10 might be low. In addition, if the entire cover is entirely made of rubber, since the cover is a flexible member, there is a possibility of an increase in weight for structural reasons such as ensuring strength for holding the entire shape. Therefore, by adopting the resin cover 60, the attachment workability to the main body portion 10 is improved and the weight is reduced. In addition, when the opening and closing angle of the claw member 30 by the swing of the driving portion 17 is 0 to 60 degrees, the shape of the movable portion 75 at the boundary between the tubular portion 72 and the lid portion 73 is designed in accordance with the state in which the opening and closing angle is 30 degrees which is the median value. This makes it possible to balance the degree of deformation of the rubber cover 70 when the claw member 30 is fully opened and the degree of deformation of the rubber cover 70 when the claw member 30 is fully closed.

Next, a method of attaching the extension member 50, the resin cover 60, and the rubber cover 70 will be described. First, in a state where the resin cover 60 and the rubber cover 70 are not attached to the main body portion 10, the extension member 50 to which the claw member 30 is not fixed is fixed to the driving portion 17. Next, the attachment 40 is fixed to the main body portion 10, and the resin cover 60 and the rubber cover 70 are sequentially attached to the attachment 40 so as to wrap the main body portion 10. At this time, the claw member 30 is not attached to the extension member 50. Therefore, the resin cover 60 can be easily attached to the attachment 40 from the distal end side of the main body portion 10. In addition, the rubber cover 70 is attached to the resin cover 60 such that the narrow portion 53 of the extension member 50 is inserted into the opening 76 of the rubber cover 70.

Herein, the narrow portion 53 of the extension member 50 is substantially linear. Therefore, when the rubber cover 70 is attached to the main body portion 10, it is easy to insert the extension member 50 into the opening 76. Next, the claw member 30 is fixed to the narrow portion 53 exposed from the rubber cover 70. In this way, the claw member 30 is fixed to the extension member 50 without interfering with the rubber cover 70.

A screw S3 for fixing the extension member 50 and the claw member 30 is exposed from the rubber cover 70 in a detachable manner. Thus, the claw member 30 can be easily replaced by removing the screw S3 without removing the rubber cover 70. Therefore, the replacement workability of the claw member 30 is improved. Further, regardless of the shape of the claw member 30, the main body portion 10 can be waterproofed by the rubber cover 70. Therefore, versatility is also improved. Further, the rubber cover 70 does not cover the claw member 30. Therefore, the claw member 30 can be freely designed in accordance with an object to be grasped. Therefore, the object can be appropriately gripped by the claw member 30.

Further, in the present embodiment, a mechanically unstable waterproof member such as a rubber cover is not interposed between the claw member 30 and the object to be gripped. Therefore, it is possible to prevent a gripping failure caused by the presence of the waterproof member. That is, in the case of the glove-shaped waterproof member that covers the entire claw members of the robot hand up to the distal end thereof, it is needed to set the dimension of the waterproof member to be relatively large for attachment. As a result, the waterproof member in a state of being sandwiched between the claw members and the object to be gripped might exhibit unstable behavior. For this reason, there is a concern that the gripping might fail or the gripped object might fall due to the waterproof member slipping. In addition, there is also a possibility that such a waterproof member might be damaged by local application of stress and might lose waterproof Further, when the waterproof member has performance. adhesiveness, there is a possibility that the claw member and the object adhere to each other after the gripping of the object is finished and the object cannot be released. In addition, fragments of the waterproof member generated at the time of breakage might enter the main body portion 10 to cause malfunction. Thus, there might be various problems. In the waterproof mechanism according to the present embodiment, such a problem can be avoided.

In the above-described embodiment, the tubular portion 72 has a substantially cylindrical shape so as to correspond to the bracket portion 13 having a substantially cylindrical shape. For example, when the bracket portion 13 has a substantially prismatic shape, the tubular portion 72 may also have a substantially prismatic shape so as to correspond thereto. In the embodiment described above, the robot hand 1 in which the number of the claw members 30 is three has been described as an example, but the embodiment is not limited thereto. That is, the waterproof mechanism for a robot hand according to the present embodiment can be applied to a robot hand including two or more claw portions.

The cross-sectional shape of each of the narrow portions 51 and 53 is rectangular, but is not necessarily limited to such a shape. For example, the cross-sectional shape may be a circle, or may be a polygon such as a triangle or a pentagon. Also in this case, it is preferable that the cross-sectional shape of the narrow portion 53 and the shape of the opening 76 are complementary shapes from the viewpoint of waterproofness. For example, if the cross-sectional shape of the narrow portion 53 is triangular, the shape of the opening 76 is also preferably triangular.

If the cross-sectional shape of the narrow portion 53 is pentagonal, the shape of the opening 76 is also preferably pentagonal.

In addition, as described above, the distal end portion of the extension member 50 to which the proximal end portion of the claw member 30 is fixed and the location of the driving portion 17 to which the proximal end portion of the extension member 50 is fixed are interchangeable in shape. Therefore, at least one of the small portions 51 and 53 may be curved with a constant curvature or may have a shape bent in the middle as long as the compatibility is not impaired and the narrow portion 51 is not difficult to pass through the opening 76.

The shapes of the narrow portions 51 and 53 are not limited to the same. The narrow portion 51 has a thin plate shape in consideration of ease of fixing the extension member 50 to the driving portion 17, but is not limited thereto. As described above, the distal end portion of the extension member 50 to which the proximal end portion of the claw member 30 is fixed and the location of the driving portion 17 to which the proximal end portion of the extension member 50 is fixed are interchangeable in shape. For example, the cross-sectional shape of the narrow portion 51 may be the same as that of the enlarged portion 52 as long as the compatibility is not impaired. That is, a substantially cylindrical enlarged portion 52 may be formed from the proximal end side to the middle of the extension member 50, and a screw hole may be formed in the enlarged portion 52.

The movable portion 75 has a cylindrical shape and a convex shape protruding to the outside of the rubber cover 70, but is not limited thereto. The movable portion 75 may have a cylindrical shape and may be recessed when viewed from the outside of the rubber cover. In this case, an opening is formed in the concave bottom portion. Further, in this case, the enlarged portion of the extension member has a size which cannot pass through the opening, and the narrow portion of the extension member can be inserted from the outside of the rubber cover 70.

Although the resin cover 60 and the rubber cover 70 are formed separately from each other, the resin cover 60 and the rubber cover 70 may be formed integrally with each other if the work of passing the extension member 50 through the opening 76 is not hindered.

Herein, a secondary effect of the present embodiment will be described. The extension member 50, the attachment 40, the resin cover 60 and a rubber cover 70 which are waterproof function components are added to an existing “robot hand having a structure capable of easily removing a claw member”. Thus, the waterproof performance of the robot hand can be ensured without impairing the performance of gripping the object by the claw member 30. If the robot hand itself is provided with a waterproof structure, the size, weight, and cost of the robot hand itself increase. Therefore, unless there is a demand for waterproofing, a robot hand having waterproof performance is rarely employed. However, it is complicated to prepare in advance a robot hand having a waterproof structure and a non-waterproof robot hand according to the convenience of an object to be grasped and to use the robot hand properly. According to the waterproof mechanism in which waterproof performance can be retrofitted as in the present embodiment, a waterproof robot hand can be easily realized by adding a waterproof function component in response to a request for waterproof performance for one robot hand. A flexible portion such as the rubber cover 70 can be easily replaced as a consumable item that degrades. Therefore, the waterproof performance can be maintained at a lower cost than the robot hand provided with the waterproof structure. This high degree of versatility can additionally be achieved with low-cost components.

While the exemplary embodiments of the present disclosure have been illustrated in detail, the present disclosure is not limited to the above-mentioned embodiments, and other embodiments, variations and variations may be made without departing from the scope of the present disclosure.

What is claimed is:

1. A waterproof mechanism for a robot hand, the waterproof mechanism comprising:
a cover covering at least a part of a main body portion of the robot hand, covering a driving portion, and including an opening; and
an extension member protruding from the opening,
wherein
the driving portion is held so as to be driven with respect to the main body portion,
a proximal end portion of the extension member is fixed to the driving portion,
a distal end portion of the extension member is fixed to a claw member of the robot hand,
a first fixing member that fixes the extension member and the driving portion to each other is covered by the cover, and
a second fixing member that fixes the extension member and the claw member to each other is detachably exposed from the cover.

2. The waterproof mechanism for the robot hand according to claim 1, wherein the cover includes a flexible portion that allows movement of the extension member associated with driving of the driving portion.

3. The waterproof mechanism for the robot hand according to claim 2, wherein
the extension member includes a narrow portion and an enlarged portion,
the narrow portion passes through the opening,
the enlarged portion has a diameter larger than a diameter of the narrow portion, and is incapable of passing through the opening,
the flexible portion includes a movable portion,
the movable portion defines a periphery of the opening and has a tubular shape, and
the movable portion is fitted to the enlarged portion.

4. The waterproof mechanism for the robot hand according to claim 3, wherein a cross section of the movable portion and a cross section of the enlarged portion have complementary shapes.

5. The waterproof mechanism for the robot hand according to claim 4, wherein the movable portion has a convex shape protruding outward from the flexible portion.

6. The waterproof mechanism for the robot hand according to claim 3, wherein
the flexible portion includes a tubular portion and a lid portion,
the lid portion is continuous with the tubular portion, and
the movable portion is formed at a boundary between the tubular portion and the lid portion.

7. The waterproof mechanism for the robot hand according to claim 6, wherein the flexible portion includes a bellows portion, and
the bellows portion is formed around the opening and extends and contracts so as to allow movement of the movable portion.

8. The waterproof mechanism for the robot hand according to claim 7, wherein the bellows portion is formed over the tubular portion and the lid portion.

9. The waterproof mechanism for the robot hand according to claim 2, wherein the cover includes a non-flexible portion, and
the non-flexible portion covers a proximal end of the main body portion relative to the flexible portion.

10. The waterproof mechanism for the robot hand according to claim 9, wherein the non-flexible portion has optical transparency for allowing the main body portion to be visually recognized.

11. The waterproof mechanism for the robot hand according to claim 1, wherein a portion of the extension member exposed from the cover extends in a rod shape.

12. The waterproof mechanism for the robot hand according to claim 1, wherein the cover is attachable to and detachable from the main body portion.
